(19) United States
(12) Patent Application Publication
(10) Pub. No.: US 2023/0289883 A1
(43) Pub. Date: Sep. 14, 2023

(54) DYNAMIC GENERATION OF A STOCK PORTFOLIO GENERATED BY SOCIAL MEDIA CONTENT

(71) Applicant: Matty Investments, LLC, Greenville, SC (US)

(72) Inventors: Barclay Layman, Greenville, SC (US); Jonathan Bryson, Greenville, SC (US)

(73) Assignee: Matty Investments, LLC, Greenville, SC (US)

(21) Appl. No.: 17/985,490

(22) Filed: Nov. 11, 2022

Related U.S. Application Data
(60) Provisional application No. 63/291,189, filed on Dec. 17, 2021.
(60) Provisional application No. 63/278,304, filed on Nov. 11, 2021.

(51) Int. Cl. G06Q 40/06; G06Q 50/00

(52) U.S. Cl. CPC G06Q 40/06; G06Q 50/01

(57) ABSTRACT

A computer-implemented method of selecting investments for an investor's portfolio is provided herein. The computer-implemented method includes the steps of: receiving data identifying one or more social-media accounts of the investor; extracting content from the one or more social-media account; generating semantic tags describing the content; identifying one or more market sectors, industries, or investments related to the content; and presenting a proposed portfolio containing the one or more market sectors, industries, or investments related to the content to the investor.

### CROSS-REFERENCE TO RELATED APPLICATIONS

The present application claims priority under 35 U.S.C. § 119(e) to U.S. Provisional Patent Application No. 63/291,189, filed Dec. 17, 2021 and to U.S. Provisional Patent Application No. 63/278,304, filed Nov. 11, 2021, the content of both of which are incorporated herein by reference in their entirety.

### BACKGROUND

Current retail stock trading applications offer an overwhelming number of public companies in which to invest. New investors are often overwhelmed by the sheer number of companies and have difficulty deciding which companies in which to invest.

### SUMMARY

One aspect of the present disclosure provides a computer-implemented method of selecting investments for an investor's portfolio. The computer-implemented method includes the steps of: receiving data identifying one or more social-media accounts of the investor; extracting content from the one or more social-media account; generating semantic tags describing the content; identifying one or more market sectors, industries, or investments related to the content; and presenting a proposed portfolio containing the one or more market sectors, industries, or investments related to the content to the investor.

In certain embodiments, the method further includes the steps of: selecting a security from the proposed portfolio; determining a general pricing trend of the security using an exponential moving average (EMA); determining an instant pricing trend of the security using another exponential moving average (EMA); determining a relative strength index (RSI) to determine an exchange momentum of the security; and determining a momentum of a current price of the security in relation to a price range of the security over a period of time using a stochastic oscillator.

### Definitions

The instant invention is most clearly understood with reference to the following definitions.

As used herein, the singular form “a,” “an,” and “the” include plural references unless the context clearly dictates otherwise.

As used in the specification and claims, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

As used herein, the term “investments” generally means investment securities and, more specifically, tradable financial assets such as equities (e.g., common stock, shares, exchange traded funds (ETFs), etc.) or fixed income instruments (e.g., debt securities, bonds, corporate bonds, etc.).

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIGS. 1A-1B illustrate graphical user interfaces of an application implementing an embodiment of the present disclosure.

FIG. 2 illustrates a graphical user interface of an application implementing an embodiment of the present disclosure.

FIG. 3 illustrates a flow diagram of creating an investment portfolio in accordance with an embodiment of the present disclosure.

### DETAILED DESCRIPTION OF THE INVENTION

It would be desirable to provide methods and system useful in customizing investment portfolios.

The present disclosure describes computer-implemented method of selecting investments for an investor's portfolio.

Embodiments of the present disclosure aid a user in selecting and trading securities (e.g., shares, stock, common stock, preferred stock, bonds, etc.). Embodiments of the present disclosure aid in addressing the overwhelming number of public companies to trade in current retail stock trading applications in the market.

Embodiments of the present disclosure generate a stock portfolio (e.g., a recommended stock portfolio) based on social media content. A targeted list of companies is created and curated specifically to each user. In one embodiment, a method of selecting investments for an investor's portfolio includes automating extraction of images and text in a user's social media account such that a service provider (e.g., a mobile application provider, a brokerage company, etc.) can match public companies to the user.

In one embodiment of the present disclosure, a method of selecting investments for an investor's portfolio can include: (a) inputting social media accounts (e.g., into a database or an application implementing the method); (b) scraping social media accounts (e.g., collecting data such as text and images from a social media account that provide indicia of a user's desired securities); (c) analyzing content using text- and image-recognition software; (d) generating “tags” or similar indication based on analysis of social content; (e) matching tags against existing database(s) of public companies; and (0 generating a portfolio of publicly traded companies.

Steps (a), (b), and (c) can require user input and return proprietary data relevant to processing, matching, or generating of steps (d) and (e). Step (e) can be considered mutually relevant to preceding steps in method. At a high-level, certain methods of the present disclosure utilize and identify a user's social media content to generate a lifestyle and interest metric of data in which predictions can be made regarding said user.

In certain embodiments, algorithmic scraping can be implemented utilizing existing methods of scraping a website for text, images and outgoing links. Such scraping can be used to generate and feed model data in a database (e.g., Big Query database) hosted in a cloud computing network (e.g., Google Cloud). Publicly traded company data (e.g., including sector, industry and generic business practice) can be stored in a database (e.g., Big Query database) hosted in cloud computing network (e.g., Google Cloud). Such stored data can become a reference point via matching tags generated as part of an initial data collection and analyzation process.

By implementing certain steps, processed, and methods described herein, users can render (or receive a rendering) a generated portfolio of companies which match interests of the user, thereby giving attachment (e.g., mental, emotional, psychological, intellectual, etc.) to the investment portfolio. For example, certain embodiments of the present disclosure can be used to generate a portfolio recommendation of companies that focus on sustainability (or other socially responsible business practices) relevant or indicated by user's social media activities and interests.

### Lifestyle Portfolio

A service provider can use methods described herein to analyze a user's social indicators (i.e., based on social media accounts, like Facebook, Twitter, and Instagram) and generate a portfolio of companies matching a user's interests based on a plurality of data (e.g., similar users, statistical indicators, etc.).

### Automated Portfolio Management

A service provider can use methods described herein to use algorithmic trading technology to automatically trade shares of users portfolio within specific sectors and industries to deliver a desired investment performance (e.g., best investment profitability performance).

### Crowdsourced Goal Based Funding

A service provider can use methods described herein to emulate a crowdfunding model of user-created goals via friends and family using a simple “social share” feature. In such a feature, anyone with the link and/or QR code can contribute funds to a user's account or goal.

Users can be encouraged to sync their social media to extract publicly traded companies that match extracted tags, posts or likes. In turn, a “life portfolio” can be suggested as a longer term investment and “goals” can be driven by traditional investment indicators and metrics (e.g., expected return, risk tolerance, desired performance, etc.).

In certain embodiments of the present disclosure, “slice trades” can enable shares to be purchased for $1, thereby enabling ownership and psychological “buy-in” to companies while limiting risk exposure.

Certain embodiments of the present disclosure can be implemented to educate new or first-time investors about the stock market by creating short term goals and suggesting a relevant investment and portfolio to reach desired goal. Goals can be encouraged to be shared with friends and family who can transfer funds towards a goal by using a mobile application.

### Technical Overview—Algorithmic Trading

Certain embodiments of the present disclosure can be implemented while operating in an intraday frame. Thirty (30) minute candles can be used to see general trends of a selected asset or security and five (5) minute candles can be used for deciding entry and exiting points of a selected asset or security.

Certain technical analyses used in connection with the present disclosure can present many advantages to an automated trading bot. The input for such analyses can be market data formatted as candles or other basic indicators described herein. Such information can be impressively powerful when used in connection with the present methods described herein. Derivative data can be extracted from market data.

### Exponential Moving Average (EMA)

EMA includes of an indicator that charts a softened-average-curve of the prices the value has been leading. EMA can be used to determine if (a) the trend is clearly defined and (b) if the trend is going up or down. This indicator will be used to see the trend of the value of the asset or security. An EMA takes the average with the close data of a candle of an asset over a defined time period (e.g., in seconds, minutes, hours, days, weeks, months, etc.) or window size (containing the values to be averaged). A window of 1 value will be a lot more susceptible to changes than a window of 50 values.

The word “exponential” can be understood to indicate that the averages are somehow weighted (i.e., the values closer to the current moment are given more importance than values farther away from the current moment), and thus entries (i.e., trades) happening in the present may desirably use an EMA.

In certain embodiments, different window sizes can use used. For example, a “fast” window size can be 9 values; a “medium” window size can be 26 values; a “slow” window size can be 50 values, wherein a larger value window (e.g., 50) and associated EMA will reveal a longer-term trend than a smaller value window and associated EMA (e.g., 9). Keep in mind that these are all prices. An EMA is an average of the price oscillations inside a defined window.

In certain embodiments, a code implemented by a computer (e.g., desktop computer, smartphone, a network processor, a virtual machine, etc.) can calculate three EMAs. For example, if the “fast” EMA is over the “medium,” and the “medium” is over the slow, the trend can be characterized as going up. In another example, if the “fast” EMA is below the “medium,” and the “medium” is below the “slow,” the trend can be characterized as going down.

### Relative Strength Index (RSI)

RSI can include an oscillator that charts the directional price movements. When the price of a security has an increasing trend, it can be characterized as having a high RSI. The more accentuated and constant the positive changes, the higher the RSI value (and vice versa).

RSI can be used to determine the exchange (i.e., buying or selling) momentum of the value of a security (or in other words, “how hard are people buying—or selling—this value?”).

An oscillator is always oscillating within two values, such as 0 and 100. The resting point of its oscillation would be half way between the two values, 50, where the trend is neither buying nor selling. A “ceiling” can be determined to be a value 70 and a “low end” (or floor) can be determined at 30. When surpassing the ceiling or floor, it can be demonstrated that a rebound is likely to happen. In other words, if the RSI is 75, it can be considered to be overbought, and will probably start to switch its trend to be more sold than bought, soon. If the RSI is 10 (far below 30), it can be considered to be oversold, and people may start to buy rather than sell.

Certain steps of methods described herein can look for these indicators to catch the correct momentum to a determined trend. If the RSI stays “too flat” (i.e., always too close to the middle point), it can mean that the volatility of that value may be too low to operate.

### Stochastic Oscillator

Stochastic oscillator is also an oscillator indicating the momentum of the current price in relation to its price range over a period of time. It intends to predict price turning points, working with the close, high and low price, believing the price tends to close near the extremes of the recent candles. It charts two curves: the fast and the slow. The last one is a simple moving average of the fast. The fast curve responds to a simple formula that aims to place the value higher if it approaches the past highest values, and vice versa.

The importance of this indicator relies on seeing the price turning points. The fast curve is representing the current momentum of the price, and it is leading the slow curve, which has less inertia. If the fast curve changes its trend, given that the slow curve has slower reactions, a crossing is produced, being a clear signal of a change of trend.

The stochastic oscillator can be used to determine how the current asset price compares to its recent historical range. This indicator can be used to check how much room for carrying on with the current trend does the value have. For example, as an oscillator within 0 and 100, stochastic oscillator can be composed of two curves: the “fast” curve (which will react quicker to the price) and the “slow” curve, which will be used as a reference. This index provides the specific instant where the price has reached its upper or lower limit (in comparison to the last values), and thus indicates a change of trend. This index also provides a proximity to this limit, meaning even when the curves still have not crossed this limit, it is not likely to change much (upper or lower). This indicator admits three configuration parameters: the length of the number of samples taken, the softening factor, and the average factor for the slow curve.

### Entry Strategy

According to certain embodiments of the present disclosure, a decision-making process will go through four (4) steps. Filters, gates, enablers or authorizers can confirm a possible entry. Each step can confirm a necessary condition in order to proceed to the following step. Fulfilling each condition is key, so it will mean that the odds of succeeding are greater.

In a first step, a general trend (e.g., of a price of a security) is determined. In this step, an EMA can be used for a defined trend in a given day. In certain embodiments, a time frame (candles) can be 30 minutes. The first step can consist of checking the trend of the asset, where the asset price may trend up, trend down or trend neither up nor down in the same day timeframe. Data can be retrieved of 30-minute candles and then three EMAs can be calculated (i.e., slow, medium and fast), and the conditions described herein can be checked. When a trend is clearly defined in the 30-minute candles frame (i.e., the general trend), it will inherently apply to the 5-minute candles frame (i.e., the instant trend). The general trend can indicate where the instant trend will lead. This means that a very defined general trend will strongly drive, as well, the instant trend, even though this last one has its fluctuations.

If the trend goes up, a system implementing the method will bring that asset towards the next comparison with a defined intention to enter this position in long and considering buying shares of that asset if the other conditions are met. On the contrary, if the trend goes down, the system can decide (if other conditions are met) to enter short.

In a second step, an instant trend is determined. In this step, an EMA can be used with a time frame (candles) of 5 minutes.

When a general trend has been found, the instant trend is checked. The analysis used in determining this trend will be essentially the same as the first step, but taking into account the decision of the previous step. In other words, it will be determined if there is a match with the trend defined before. If the general trend goes up, an instant trend that goes up is sought out. The instant trend will be the indicator that will confirm, in a much closer scale, whether the situation is suitable to operate or not. It responds to the now timeframe analysis.

In a third step, an RSI value is determined. In this step, the operation momentum is evaluated. The RSI indicator can be used in connection with a time frame (candles) of 5 minutes. In this step, the entry conditions are defined. The RSI will be suitable to enter when it is placed neither too high nor too low for a specific trend. For example, the conditions (analyzed through code executed on a computer) can be: if the RSI oscillator is above 50 and below 70, it is the correct moment to buy shares; and if the RSI oscillator is below 50 and above 30, it is the correct moment to sell shares.

In a fourth step, the stochastic crossing is determined. In this step, the current price is analyzed relative its recent history. In this step, indicators can be stochastic curves. Stochastic curves can be used in connection with a time frame (candles) of 5 minutes. In this step, the last filter is the stochastic oscillator. After passing such a filter, an entry (i.e., a purchase) can be authorized. This oscillator can have a ceiling and a low end, so the code (executed on a computer) can decide carefully and precisely when to enter. This indicator consists of two curves, which must be compared within themselves. For example, the conditions (analyzed through code executed on a computer) can be: if the RSI oscillator is still below 70 and the fast curve (K) is over the slow curve (D), it is the correct moment to buy shares; and if the RSI oscillator is still above 30 and the fast curve (D) is over the slow curve (K), it is the correct moment to buy shares.

Note that the further the value of both curves is from the end (either the upper limit or the lower limit), the better because the oscillator has still room to continue with the trend.

In a final step (having gone through the four filters to decide the entry), the code will decide the value is suitable to enter, either long or short. It will proceed with a coherent entry with its analysis, buying or selling shares of that asset.

Once the order is executed, different situations can manifest. For example, the order may not go through if the order was placed in an aggressive price movement. For example, if a determination was made to buy a share at $35.87 and a limit order was placed at such a price, but the price is rising with a lot of momentum and, by the time the order reaches the market, the price is $35,89, the order will not go through. If the order goes through, the price was accepted and the transaction made and a position was opened.

### Social Sentiment

Social sentiment describes users' preferences based on social media extraction. Social media sentiment analysis is the process of interpreting and determining whether the social media collected text data is positive, negative, neutral, or similarly characterized. Social media sentiment analysis goes beyond just collecting and counting the number of mentions, comments, or hashtags. Analyzing sentiment can provide deeper insight into the attitudes, opinions, and emotions behind the text or other postings of users. Social media sentiment analysis can determine whether a collected social media post (e.g., a Facebook post) was mentioning something in a positive or negative light. Social media sentiment analysis gives context to a number of mentions or in a specific connection to brands that happen to also be publicly traded companies.

Stock sentiment analysis can be conducted using AI/Machine Learning techniques and analytical processes. Sentiment output can be neutral, positive, negative, or similar characterized. News feeds (e.g., real-time news from over 3,000 news feeds) can be used to calculate AI/ML Stock Sentiment. All major news and social media feeds can be covered and used in the AI model to calculate sentiment analysis for each stock covered. The newsfeed can be supplied by IEX Cloud.

A multitude of information can be generated on a position or portfolio level, such as portfolio statistics, financial data, P&L, financial metrics, AI/Machine Learning, tear sheets, custom reports. Technical indicator charts with AI/Machine Learning for over 200 technical indicators and candlestick pattern recognition can be used in connection with certain embodiments of the present disclosure.

### Exemplary User Interface

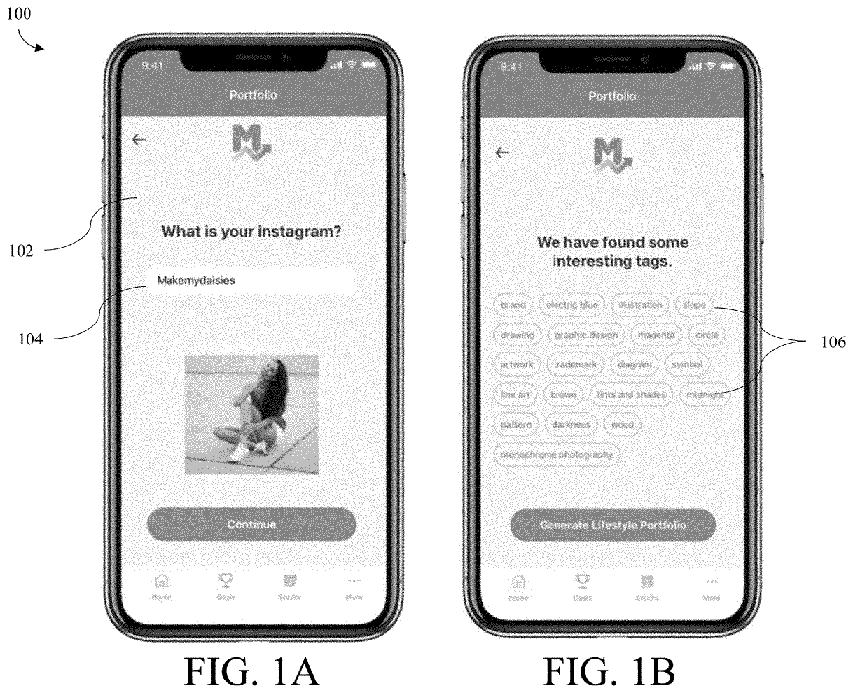

Referring now to the drawings, in FIGS. 1A-1B, a user device 100 for implementing the method of selecting investments for an investor's portfolio is illustrated. User device 100 is illustrated as a smartphone. User device 100 can be any device capable of executing methods described herein, such as a smartphone, a tablet computer, a personal computer, a laptop computer, a desktop computer, a cloud-computing device, a cloud computer network, a virtual machine, and the like. User device 100 includes a processor configured to implement the computer-implemented steps described herein. User device 100 is illustrated a graphical user interface (GUI) 102 configured and adapted to transmit and receive information to and from a user. GUI 102 include a data entry field 104 for a user to input data (e.g., related to a social media account, such as an Instagram, Facebook, or Twitter account). A plurality of tags 106 are illustrated from which a user can select to update the preferences of a user's portfolio.

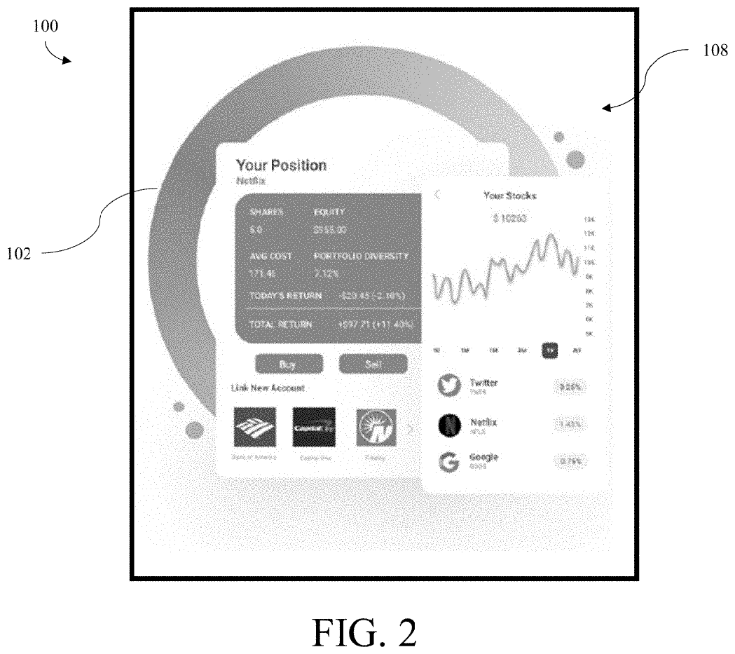

Referring now to FIG. 2, GUI 102 is illustrated displaying a portfolio summary 108. Portfolio summary 108 can include information such as information related to a specific security, such information including the number of shares, equity position, average cost per share, daily return, total return, and the like.

### Exemplary Method

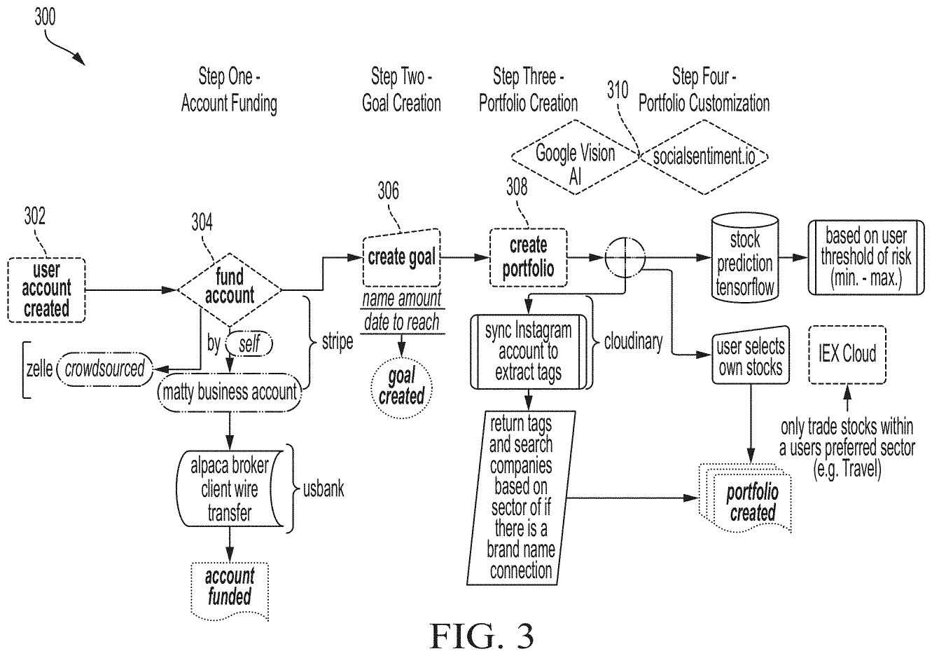

Referring now to FIG. 3, a method 300 of generating a portfolio is illustrated. At step 302, a user account is created. At step 304, the account is funded. The account may be funded in a plurality of ways, such as self funding (i.e., an Electronic Funds Transfer transaction, a bank or wire transfer, etc.) or crowdsourced funding. At step 306, a goal is created. The goal can be driven by traditional investment indicators and metrics (e.g., expected return, risk tolerance, desired performance, retirement date, etc.). At step 308, a portfolio is created. The portfolio can be curated based on desired longer term investments.

At step 310, the portfolio is customized. Investments and companies selected for an investor's portfolio can be curated by automating extraction of images and text from a user's social media account such that a service provider (e.g., a mobile application provider, a brokerage company, etc.) can match public companies to the user. The user's social media accounts can be scraped (e.g., collecting data like text and images from a social media account that provide indicia of a user's desired securities). As illustrated, an Instagram account can be synced (e.g., in connection with services such as cloudinary) such that “tags” can be extracted. Text and image recognition software services (e.g., Google Vision AI, socialsentiment.io, etc.) can be used in connection with images (or text) such that extracted information may be used to curate the portfolio to a user's interests and passions. As illustrated, tags can be returned and companies can be searched based on the sector or if there is a brand-name connection. Further, a user can manually select specific stocks to add to a portfolio. This manual selection can be used to help curate the portfolio (e.g., using portfolios of users with similar interests to make portfolio suggestions). Once a portfolio has been customized, exchanges can be made in accordance with a user's preferences (i.e., based on sector), risk tolerance, or other user settings.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

1. A computer-implemented method of selecting investments for an investor's portfolio, the computer-implemented method comprising:
receiving data identifying one or more social-media accounts of the investor;
extracting content from the one or more social-media account;
generating semantic tags describing the content;
identifying one or more market sectors, industries, or investments related to the content; and
presenting a proposed portfolio containing the one or more market sectors, industries, or investments related to the content to the investor.

2. The computer-implemented method of claim 1, wherein the proposed portfolio has a composition weighted at least partially based on a distribution of content within the one or more social media accounts.

3. The computer-implemented method of claim 1, wherein the semantic tags are generated using a previously trained machine-learning estimator.

4. The computer-implemented method of claim 1 further comprising:
(a) selecting a security from the proposed portfolio;
(b) determining a general pricing trend of the security using an exponential moving average (EMA);
(c) determining an instant pricing trend of the security using another exponential moving average (EMA);
(d) determining a relative strength index (RSI) to determine an exchange momentum of the security; and
(e) determining a momentum of a current price of the security in relation to a price range of the security over a period of time using a stochastic oscillator.

5. The computer-implemented method of claim 4 further comprising:
(f) executing an exchange of the security.
